(19) United States
(12) Patent Application Publication
(10) Pub. No.: US 2011/0018268 A1
(43) Pub. Date: Jan. 27, 2011

(54) WIND TURBINE AND ROTOR BLADE WITH REDUCED LOAD FLUCTUATIONS

(75) Inventors: Herman Snel, Bergen (NL); Herman Willem Marie Hoeijmakers, Enschede (NL)

Correspondence Address: YOUNG & THOMPSON, 209 Madison Street, Suite 500, Alexandria, VA, 22314, US

(73) Assignee: STICHTING ENERGIEONDERZOEK CENTRUM NEDERLAND, Petten (NL)

(21) Appl. No.: 12/673,827

(22) PCT Filed: Aug. 15, 2008
(86) PCT No.: PCT/NL08/50549

§ 371 Date: Feb. 17, 2010

(30) Foreign Application Priority Data
Aug. 17, 2007 (NL) 2000819

(51) Int. Cl. H02P 9/04

(52) U.S. Cl. 290/44

(57) ABSTRACT

A wind turbine includes a rotor having a number of rotor blades. At least one rotor blade has openings. The rotor blade has air-displacement elements which, in use, alternately force air out of and into the openings. A sensor is provided for detecting wind speed fluctuations. A control unit is provided for controlling the air-displacement elements depending on the wind speed fluctuations detected by the sensor. The rotor blade has an aerodynamic profile with a suction side and a pressure side. At least one opening is provided on the suction side. The control unit is designed for operating the air-displacement elements of the opening on the suction side if the sensor has detected a positive speed fluctuation. At least one opening is provided on the pressure side. The control unit is designed for operating the air-displacement element of the opening on the pressure side if the sensor has detected a negative speed fluctuation.

The invention relates to a wind turbine which has a rotor having a number of rotor blades.

When in use, the rotor of a wind turbine is subjected to a flap load and a lag load by the forces exerted on the rotor blades, as the lifting force and resistance force of the flow around the rotor blade form a resultant force which can be divided into a flap force and a lag force. The flap force is directed essentially parallel to the axis of rotation of the rotor, while the lag force is at right angles thereto and propels the rotor blades. The flap and lag forces result in internal bending moments in the rotor blades, which increase from the tip end to the root end. The root end of the rotor blades is connected to a hub of the rotor. The bending moments at the location where the root end is connected to the hub are significant.

The angle of incidence α of the flow around the rotor blades is defined by the wind speed of the approaching wind and the tangential blade speed. The wind speed comprises an average wind speed onto which positive and negative wind speed fluctuations have been superpositioned. The average wind speed varies slowly with respect to the time scale of the wind speed fluctuations. The variations in the average wind speed can, for example, be compensated for by a blade angle adjustment of the rotor blades. However, the blade angle adjustment is too slow to be able to follow the wind speed fluctuations.

Due to the wind speed fluctuations, the angle of incidence of the flow around the rotor blades varies. If the direction of the wind speed varies—that is to say the speed vector of the wind fluctuation does not coincide with the speed vector of the average speed—the angle of incidence changes. A fluctuation in the magnitude of the wind speed also results in a change in the angle of incidence. When the magnitude of the wind speed fluctuates, the blade speed initially remains the same, due to the inertia of the rotor. If, as a result of the fluctuation, the wind speed essentially parallel to the axis of rotation of the rotor changes, while the blade speed at essentially right angles thereto remains unchanged, the angle of incidence changes.

The lift coefficient of the rotor blades depends on the angle of incidence α—according to the C_{L}-α curve. As wind turbines operate at small angles of incidence, a fluctuation in the angle of incidence leads to a relatively large change in the lifting force and thereby in the flap and lag force. The wind speed fluctuations therefore cause considerable fluctuations in the flap and lag load on the rotor blades. Especially with rotors having a relatively large diameter, these load fluctuations may result in problems with regard to stiffness and strength.

It is an object of the invention to provide a wind turbine in which the load fluctuations are reduced.

According to the invention, this object is achieved by a wind turbine, comprising a rotor having a number of rotor blades, in which at least one rotor blade of the wind turbine is provided with openings, air-displacement means for alternately forcing air out of and into said openings, a sensor for detecting wind speed fluctuations, and a control unit for controlling the air-displacement means depending on the wind speed fluctuations detected by the sensor, in which the rotor blade which is provided with the openings has an aerodynamic profile with a suction side and a pressure side, in which at least one opening is provided on the suction side, and in which the control unit is designed for operating the air-displacement means of the opening on the suction side if the sensor has detected a positive speed fluctuation, in which at least one opening is provided on the pressure side, and in which the control unit is designed for operating the air-displacement means of the opening on the pressure side if the sensor has detected a negative speed fluctuation. In each case one or more openings are provided on both the suction side and on the pressure side.

The air-displacement means according to the invention generate so-called synthetic jets from the opening. A synthetic jet comprises a number of vortices which are formed by alternately blowing out and sucking in fluid through an opening. Each time mass is ejected, a vortex is emitted from the opening as a result of separation, whereas the opening acts as a drain when mass is flowing in. Every opening directs such a series of vortices into the flow around the rotor blade. The vortices of the synthetic jets influence said flow around the rotor blade—the vortices are able to seemingly change the camber of the aerodynamic profile of the rotor blade.

According to the invention, the synthetic jets are used to reduce the fluctuations in flap load and lag load. The sensor measures the wind speed fluctuations—a generally known acceleration sensor can be used for this purpose. When it is assumed that a positive speed fluctuation is detected by the sensor, a positive speed fluctuation will result in an increase in the angle of incidence and thus of the lifting force—according to the C_{L}-α curve. Said increased lifting force causes a fluctuation of the flap load and lag load in the rotor blade. However, according to the invention, these load fluctuations are reduced as a result of the fact that the sensor emits a signal to the control unit, which depends on the detected positive wind speed fluctuation. On the basis of the signal it receives, the control unit then operates the air-displacement means in such a manner that synthetic jets are generated which counteract the effect of the detected wind speed fluctuation.

If a positive speed fluctuation is detected, the control unit operates the air-displacement means in such a manner that the camber of the aerodynamic profile of the rotor blade decreases. If the sensor sends a signal to the control unit which corresponds to a positive speed fluctuation, the control unit operates the air-displacement means of the opening on the suction side of the rotor blade in order to generate synthetic jets from said opening. As a result thereof; the apparent camber of the aerodynamic profile of the rotor blade is reduced. This means that the lifting force is reduced—the C_{L}-α curve moves to the right. The reaction to a detected positive speed fluctuation is thus a reduction in the lifting force and thus in the flap load and lag load.

Conversely, when a negative speed fluctuation is detected, synthetic jets are generated from the opening on the pressure side of the rotor blade. If the sensor detects a negative speed fluctuation, the apparent camber of the aerodynamic profile of the rotor blade can then, on the contrary, be increased by means of the synthetic jets operated by the control unit.

The modification to the apparent camber of the aerodynamic profile of the rotor blade by means of synthetic jets is (much) quicker than a blade angle adjustment. The response time of the synthetic jets is sufficiently short to compensate for the lifting force of the rotor blade in case of wind speed fluctuations, so that load fluctuations are reduced.

It should be noted that a wind turbine with synthetic jets is known from EP1674723. In this case, the synthetic jets are used in order to influence the separation point on the suction side of the rotor blade. Under changing wind conditions, for example during a storm, the wind speed may suddenly cause an excessively great lifting force. In order to prevent the rotor blade from being overloaded, the synthetic jets on the suction side of the rotor blade are designed to move the separation point forward, that is to say to the leading edge of the rotor blade. However, according to the invention, the synthetic jets are not used to influence the separation point, but to reduce the load fluctuations on a wind turbine by modifying the apparent camber of the aerodynamic profile of the rotor blade. According to the invention, the synthetic jets are therefore arranged on both the suction side and the pressure side of the rotor blade—in contrast to the wind turbine known from EP1674723. As a result thereof, the synthetic jets can be operated on the suction side or pressure side, depending on the detected wind speed fluctuations, so that load fluctuations resulting from said wind speed fluctuations are attenuated around an average value.

Furthermore, it should be noted that a wind turbine blade is known from WO2004/0099608, in which flexible flaps are provided on the suction side and pressure side in order to modify the lifting force. However, no mention is made of using synthetic jets in order to modify the apparent camber of the aerodynamic profile of the rotor blade.

In addition, it should be noted that a wind turbine is disclosed in US2004/0201220, in which an elongate slot is provided near the trailing edge of the rotor blade. Via the elongate slot, air can be blown into the flow around the rotor blade. However, the slots do not form synthetic jets which alternately force air out of and into the openings. Also, the slot is only provided on one side of the rotor blade.

It is possible for each of the rotor blades to have a leading edge and a trailing edge, with the opening being provided near the trailing edge. For example, each rotor blade has a chord line in cross section, which extends between the leading edge and the trailing edge, the openings being provided on the trailing edge or at a distance from the trailing edge which is less than 20% of the length of the chord line, preferably less than 10% of the chord line. In the region of the trailing edge, synthetic jets are particularly effective for modifying the apparent camber in order to reduce load fluctuations.

The sensor may be designed in various ways. In one embodiment, the sensor comprises an acceleration sensor, which is fitted on the rotor blade. The acceleration sensor is situated, for example, near the tip of the rotor blade, so that the acceleration of the blade tip is measured. If the span is defined as the distance between the root end and the tip end of the rotor blade, the sensor which is in the form of an acceleration sensor is, for example, provided at a distance from the root end which is greater than 80% or 90% of the span. The acceleration of the blade tip is in fact two time integrations ahead of deformations, that is to say internal stresses, so that the modification of the apparent camber can prevent load fluctuations on the root of the blade in time.

In addition, it is possible for the sensor to comprise a pressure sensor which is designed for measuring the pressure difference between the suction side and the pressure side. The variation in pressure difference between the suction side and the pressure side also forms an indication of the wind speed fluctuations.

The sensor may furthermore comprise a wind speed meter. The wind speed meter is, for example, designed as a pressure sensor inside the nose of the rotor blade, by means of which the total pressure is measured. The wind speed fluctuations can be deduced directly by measuring the wind speed.

The sensor in the form of a pressure sensor or wind speed meter is preferably provided near the root of the rotor blade, such as at a distance from the root end which is less than 20% of the span.

The openings can also be arranged at a distance from the root end which is greater than 50% of the span, preferably between 60-90% of the span. In the region of the tip of the rotor blade, the openings are particularly effective in modifying the apparent camber in order to reduce load fluctuations.

According to the invention, the openings can be designed in various ways. For example, each of the openings on the suction side and the pressure side is in the shape of an elongate slot. Instead thereof, the rotor blades can each be provided with a series of openings. In this case, it is possible for said openings to be arranged at a distance from one another in the direction of the span. For example, the distance between the openings is substantially 1-10% of the length of the chord line, such as 1-2% of the length of the chord line.

In one embodiment, the air-displacement means are designed so as to alternately force air out of and into the openings at a frequency of 0.1-500 Hz, such as 0.1-100 Hz. These frequencies are particularly suitable for modifying the apparent camber of the rotor blade.

In one embodiment, each rotor blade has an azimuth angle which is defined by the angle from the vertical which extends upwards from the axis of rotation up to said rotor blade, viewed in the direction of rotation, in which an angle sensor is provided for detecting the azimuth angle, and the control unit is designed for switching on the air-displacement means at an azimuth angle between 135-245° and switching off the air-displacement means at an azimuth angle outside this range. While the rotor blades move past the tower of the wind turbine, the flow approaching the rotor blades changes both direction and speed. This is the result of air accumulating against the tower and/or the wake behind the tower—the rotor blades can rotate in front of or behind the tower. The influence of the tower on the flow around the rotor blade can be limited by switching on the air-displacement means in order to generate synthetic jets when the rotor blade moves past the tower, while not emitting any synthetic jets for the remainder, for example.

The air-displacement means may be designed in various ways. For example, the air-displacement means are provided with at least one air chamber, which is provided inside the rotor blade and is connected to at least one opening, the air chamber being provided with means for changing the volume of the air chamber for forcing air out of and into the associated opening. In this case, it is possible for several air chambers to be provided, each of which is connected to in each case one opening or several openings. For example, several openings or an elongate opening are/is connected to a common elongate air chamber.

In one embodiment, the means for changing the volume of the air chamber is a flexible membrane. Each air chamber is formed by a hollow inner space in the rotor blade. Each air chamber has a volume which is, for example, delimited by one of the openings and the flexible membrane. The flexible membrane can be actuated. By deforming the flexible membrane towards the opening, i.e. to the outside, the volume is reduced. In this case, an amount of air is forced out of the air chamber in order to create a vortex. While it is being emitted, the air flows “straight” out of the opening. Then, the flexible membrane is reshaped, so that the volume of the air chamber increases. This results in a reduced pressure in the air chamber, so that air is drawn in from outside the opening. This leads to a mass flow into the air chamber. In this case, the air flows along the surface of the rotor blade towards the opening and then turns off to the inside. The net mass flow flux through the opening is equal to zero. Thereafter, the flexible membrane can move outwards again in order to generate a further vortex. The succession of vortices forms a synthetic jet.

The air-displacement means may, instead of the flexible membrane, comprise a piston which can reciprocate in the air chamber in order to generate vortices. Other embodiments for generating synthetic jets are also possible according to the invention.

The invention also relates to a rotor having a number of rotor blades, in which at least one rotor blade is provided with openings, air-displacement means for alternately forcing air out of and into said openings, a sensor for detecting wind speed fluctuations, and a control unit for controlling the air-displacement means depending on the wind speed fluctuations detected by the sensor, in which the rotor blade which is provided with the openings has an aerodynamic profile with a suction side and a pressure side, in which at least one opening is provided on the suction side, and in which the control unit is designed for operating the air-displacement means of the opening on the suction side if the sensor has detected a positive speed fluctuation, in which at least one opening is provided on the pressure side, and in which the control unit is designed for operating the air-displacement means of the opening on the pressure side if the sensor has detected a negative speed fluctuation.

The invention also relates to a rotor blade, comprising openings, air-displacement means for alternately forcing air out of and into said openings, a sensor for detecting wind speed fluctuations, and a control unit for controlling the air-displacement means depending on the wind speed fluctuations detected by the sensor, in which the rotor blade has an aerodynamic profile with a suction side and a pressure side, in which at least one opening is provided on the suction side, and in which the control unit is designed for operating the air-displacement means of the opening on the suction side if the sensor has detected a positive speed fluctuation, in which at least one opening is provided on the pressure side, and in which the control unit is designed for operating the air-displacement means of the opening on the pressure side if the sensor has detected a negative speed fluctuation.

Furthermore, the invention relates to a method for operating a wind turbine which is provided with a rotor having a number of rotor blades, at least one rotor blade of which is provided with openings, air-displacement means for alternately forcing air out of and into said openings, a sensor for detecting wind speed fluctuations, and a control unit for controlling the air-displacement means depending on the wind speed fluctuations detected by the sensor, in which the rotor blade which is provided with the openings has an aerodynamic profile with a suction side and a pressure side, in which at least one opening is provided on the suction side, and in which at least one opening is provided on the pressure side, which method comprises:
the sensor detecting a wind speed fluctuation;
transmitting a signal from the sensor to the control unit, which signal corresponds to the wind speed fluctuation detected by the sensor,
the control unit controlling the air-displacement means depending on the signal of the sensor,
the control unit operating the air-displacement means of the opening on the suction side if the sensor has detected a positive speed fluctuation,
the control unit operating the air-displacement means of the opening on the pressure side if the sensor has detected a negative speed fluctuation.

The invention will now be explained in more detail below merely by way of example with reference to the attached drawing, in which:

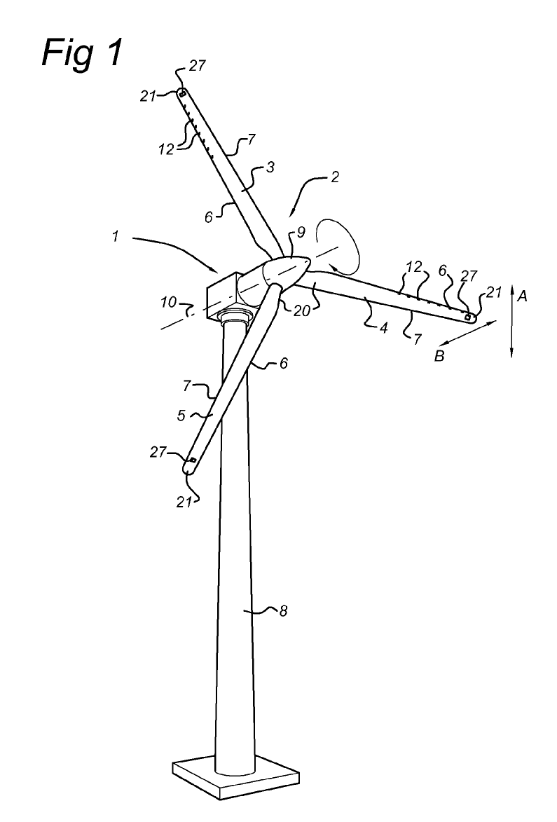

FIG. 1 shows a perspective view of a wind turbine comprising a rotor having a number of rotor blades according to the invention;

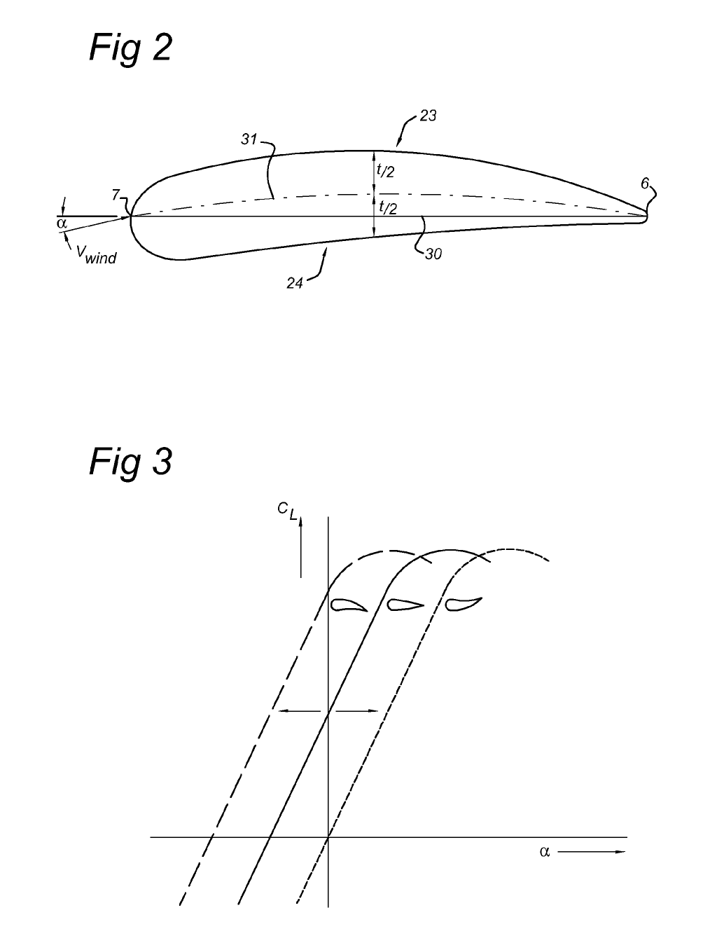

FIG. 2 shows a cross-sectional view of a rotor blade of the wind turbine illustrated in FIG. 1, in which the chord line and the mean camber line are illustrated;

FIG. 3 shows a number of C_{L}-α curves;

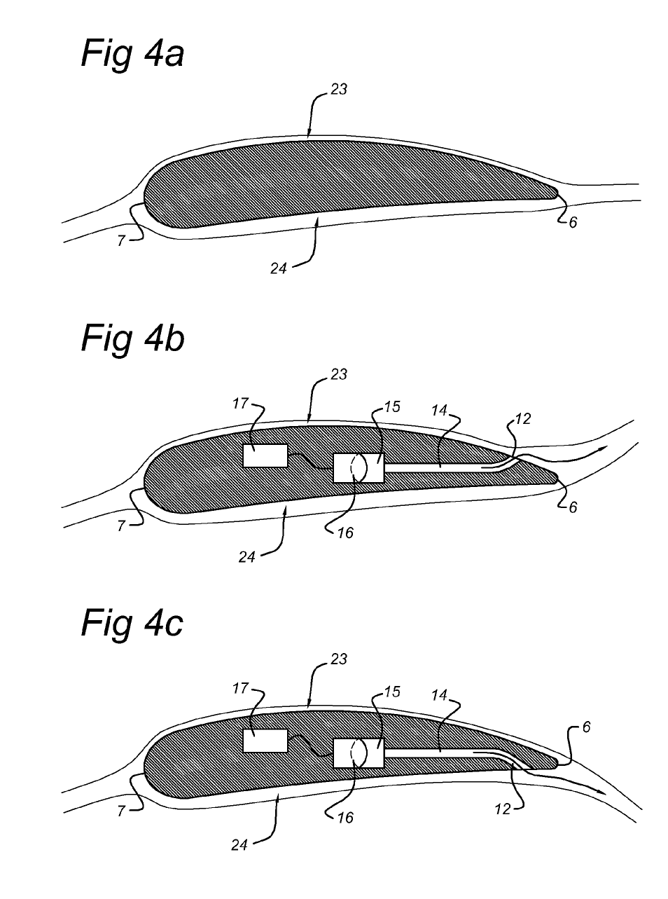

FIGS. 4a-c show cross-sectional views of a rotor blade of the wind turbine illustrated in FIG. 1, in which the normal flow around the rotor blade, the flow with synthetic jets on the suction side and the flow with synthetic jets on the pressure side are illustrated, respectively;

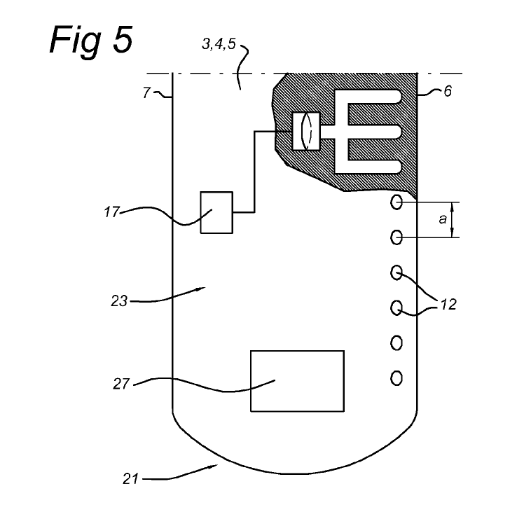

FIG. 5 shows a partially cut-open top view of a tip section of a rotor blade of the wind turbine illustrated in FIG. 1.

The wind turbine illustrated in FIG. 1 is denoted overall by reference numeral 1. In this exemplary embodiment, the wind turbine 1 is built on land. The wind turbine 1 comprises a tower 8 and a rotor 2, which is connected to the tower 8 so as to be rotatable about an axis of rotation 10.

The rotor 2 comprises a hub 9 and a number of rotor blades 3, 4, 5. Although in this exemplary embodiment, the rotor 2 has three rotor blades, more or fewer rotor blades may be provided. Each rotor blade 3, 4, 5 has a root end 20 and a tip end 21. The root end 20 is attached to the hub 9, while the opposite tip end 21 is unattached. The rotor blades 3, 4, 5 each comprise a leading edge 7 and a trailing edge 6, viewed in the direction of rotation of the rotor 2.

Each rotor blade 3, 4, 5 extends radially outwards from the root end 20 at the hub 9 to the tip end 21. The distance between the root end 20 and the tip end 21 determines the span of the rotor blade 3, 4, 5. The rotor blade 3, 4, 5, in cross section, has an aerodynamic profile with a chord line 30, which is defined by a straight line between the leading edge 7 and the trailing edge 6 of said profile (see FIG. 2). The angle between the relative speed of the air and the chord line is the angle of incidence α.

In addition, the aerodynamic profile has a mean camber line 31, which is defined by the central line between the top and bottom surface illustrated in FIG. 2. When air flows around the rotor blade, there is reduced pressure on the top surface (suction side 23), while the bottom surface of the profile forms a pressure side 24. The pressure on the pressure side 24 is higher than the pressure on the suction side 23.

In this exemplary embodiment, the aerodynamic profile varies across the span of the rotor blade 3, 4, 5, that is to say the chord line 30 and the mean camber line 31 are dependent on the distance from the hub 9 of the rotor 2.

The ratio between the lift coefficient C_{L} and the angle of incidence α is illustrated in FIG. 3. At a small angle of incidence, the lift coefficient C_{L} increases proportionally to the angle of incidence α. Each profile has a C_{L}-α curve, which depends, inter alia, on the mean camber line of the profile. In FIG. 3, three C_{L}-α curves are shown.

Each rotor blade 3, 4, 5 in this exemplary embodiment comprises a series of openings 12. Instead of a series of openings 12, an elongate slot may be provided in each rotor blade 3, 4, 5. Although the openings 12 may be situated at any suitable location on the outer surface of the rotor blades 3, 4, 5, the openings 12 in this exemplary embodiment are arranged on the suction side 23 and the pressure side 24 on the outer half of the rotor blades 3, 4, 5 and near the trailing edge 6.

The openings 12 are designed for emitting synthetic jets, that is to say a succession of vortices. In order to generate the synthetic jets, the rotor blades 3, 4, 5 comprise air-displacement means for alternately forcing air out of and into the openings 12 (see FIGS. 4b, 4c and 5).

The air-displacement means in this exemplary embodiment comprises several air chambers 15, which are each connected to the openings 12 by means of a duct 14. Each air chamber 15 is provided with a flexible membrane 16, which can be deformed by a drive mechanism (see the dotted line and the dashed line in FIGS. 4a-c and 5). The drive mechanism causes the flexible membrane 16 to vibrate. The vibration frequency is, for example, between 0.1-500 Hz. When the flexible membrane 16 of an air chamber 15 moves towards the opening 12 which is connected thereto, the volume of the air chamber 15 decreases. This results in a quantity of air being forced out of said opening 12. This leads to a small vortex near the opening 12, which opens on the suction side 23 or pressure side 24.

After this vortex has been emitted, the flexible membrane 16 moves away from the opening 12, as the flexible membrane 16 vibrates. This means that the volume of the air chamber 15 increases, and air is drawn in through the opening 12 from outside the rotor blade. As a result thereof, the air in the air chamber 15 is replenished, so that the mass flow flux through the opening 12 is substantially equal to zero.

Subsequently, the drive mechanism moves the flexible membrane 16 back in the direction of the opening 12 in order to produce a further vortex. The vibration of the flexible membrane 16 results in a succession of vortices from the openings 12. Due to the interaction of the vortices, each succession forms a synthetic jet. The air forced out of the opening 12 is formed by the air which surrounds the rotor blades 3, 4, 5.

In this exemplary embodiment, each rotor blade 3, 4, 5 has a sensor 27 in the form of an acceleration sensor, which is arranged at the tip end 21 of each rotor blade 3, 4, 5. The sensor may, incidentally, be designed differently. For example, the sensor may be a pressure sensor for measuring the pressure difference between the suction side 23 and the pressure side 24 or a speed meter in the nose of the rotor blade 3, 4, 5.

Each rotor blade 3, 4, 5 has a control unit 17 for controlling the air-displacement means of the rotor blades 3, 4, 5. The control unit 17 of each rotor blade 3, 4, 5 can control the air-displacement means thereof on the basis of a signal that said control unit 17 receives from the associated sensor 27 of said rotor blade 3, 4, 5 for detecting wind speed fluctuations. The sensor 27 measures the local wind speed fluctuation and the control units 17 of the rotor blades locally control the synthetic jets on the basis thereof.

The wind turbine 1 operates as follows. The wind flow around the wind turbine 1 is turbulent, resulting in fluctuations in the wind speed. If a wind fluctuation occurs, the angle of incidence α will also fluctuate. With a positive wind fluctuation, that is to say the magnitude of the wind speed increases on a small timescale, the angle of incidence α increases. As a result, the lift coefficient C_{L} greatly increases in accordance with the C_{L}-α curve shown in FIG. 3. This would lead to a greater flap force and lag force and thus load fluctuations. The reverse effect occurs in case of a negative wind fluctuation.

In order to counteract these load fluctuations, the sensors 27 measure the wind fluctuations in the form of an acceleration of the tip of the rotor blades 3, 4, 5. The sensors 27 transmit a corresponding signal to the control units 17 which operate the air-displacement means.

When a positive wind fluctuation is detected, the air-displacement means which open onto the suction side 23 of the rotor blades 3, 4, 5 are actuated. The synthetic jets on the suction side influence the flow around the rotor blades 3, 4, 5 in such a manner that the apparent camber of the aerodynamic profile of the rotor blades 3, 4, 5 decreases. As a result of the camber of the mean camber line apparently decreasing, the solid C_{L}-α curve from FIG. 3 horizontally shifts to the right. Then, the lift coefficient C_{L} at this angle of incidence α which has increased as a result of the wind fluctuation has become smaller. The increase in the lifting force resulting from a positive fluctuation in the wind speed can be compensated for by means of the synthetic jets.

When a negative wind fluctuation is detected, the air-displacement means which open onto the pressure side 24 of the rotor blades 3, 4, 5 are actuated. The synthetic jets on the pressure side influence the flow around the rotor blades 3, 4, 5 in such a manner that the apparent camber of the aerodynamic profile of the rotor blades 3, 4, 5 increases. The decrease of the lifting force resulting from a negative fluctuation in the wind speed can likewise be compensated for by means of the synthetic jets.

The modification of the apparent camber of the aerodynamic profile by synthetic jets occurs relatively quickly—which corresponds to a relatively quick horizontal shift of the C_{L}-α curve. The response time is sufficiently small to ensure that load fluctuations are significantly reduced even with rotors of relatively large diameter.

Incidentally, the control unit 17 can actuate the air-displacement means in various ways. The air-displacement means of each rotor blade 3, 4, 5 may, for example, be designed to be switched on and off by the control unit 17. Furthermore, the control unit 17 can determine the frequency of the air-displacement means, for example a fixed frequency or a frequency which is variable and/or adjustable by the control unit.

In this exemplary embodiment, the openings 12 have been arranged at a distance from one another in the span direction of each rotor blade 3, 4, 5. As is illustrated in FIG. 5, the openings 12 are at equal distances a from one another. The distance a between the openings is, for example, approximately 1-10% of the length of the chord line. The synthetic jets from adjacent openings 12 influence one another, so that the apparent camber of the rotor blades 3, 4, 5 is influenced in an effective manner.

The openings 12 are directed in such a manner that air which is emitted from the air chamber 15 flows substantially transversely to the chord line in the flow around the rotor blade. This is advantageous for influencing the apparent camber of the rotor blades 3, 4, 5. The air which flows out of the openings 12 may, however, have a speed component in the flow direction and/or span direction of the rotor blade 3, 4, 5.

The invention is not limited to the exemplary embodiments illustrated in the figures. For example, each rotor blade may have one or more air chambers which are connected to in each case one or several openings. For example, an elongate slot is provided on the suction side and an elongate slot is provided on the pressure side, in which it is possible to generate one or more synthetic jets with each slot. In this case, it is possible for each rotor blade to comprise one or more control units, each of which is coupled to one or more air chambers. Also, the flexible membrane may be replaced by any pushing element for forcing air out or means for changing the volume of the air chamber, such as a piston which is displaceable in the air chamber. In addition, the invention relates to any aerodynamic object which rotates in a fluid and is affected by load fluctuations, such as a rotor blade of a propeller, helicopter or jet engine.

1-18. (canceled)

19. Wind turbine (1), comprising a rotor (2) having a number of rotor blades (3, 4, 5), in which at least one rotor blade (3, 4, 5) of the wind turbine (1) is provided with openings (12), air-displacement means for alternately forcing air out of and into said openings (12), a sensor for detecting wind speed fluctuations, and a control unit (17) for controlling the air-displacement means depending on the wind speed fluctuations detected by the sensor, in which the rotor blade (3, 4, 5) has an aerodynamic profile with a suction side and a pressure side, in which at least one opening (12) is provided on the suction side, and in which the control unit (17) is designed for operating the air-displacement means of the opening on the suction side if the sensor has detected a positive speed fluctuation, in which at least one opening (12) is provided on the pressure side, and in which the control unit (17) is designed for operating the air-displacement means of the opening on the pressure side if the sensor has detected a negative speed fluctuation.

20. Wind turbine according to claim 19, in which the rotor blades (3, 4, 5) each have a leading edge (7) and a trailing edge (6), and in which the openings (12) are provided near the trailing edge (6).

21. Wind turbine according to claim 19, in which the rotor blade (3, 4, 5) has a chord line in cross section, which extends between the leading edge (7) and the trailing edge (6), the openings (12) being provided on the trailing edge (6) or at a distance from the trailing edge (6) which is less than 20% of the length of the chord line, preferably less than 10% of the chord line.

22. Wind turbine according to claim 19, in which the rotor blades (3, 4, 5) each have a root end and a tip end, and in which each rotor blade (3, 4, 5) has a span which is defined by the distance between the root end and the tip end.

23. Wind turbine according to claim 22, in which the openings (12) are provided at a distance from the root end which is greater than 50% of the span, preferably between 60-900 of the span.

24. Wind turbine according to claim 19, in which the sensor comprises an acceleration sensor.

25. Wind turbine according to claim 24, in which the sensor is arranged at a distance from the root end which is greater than 80% or 90% of the span.

26. Wind turbine according to claim 19, in which the sensor comprises a pressure sensor which is designed for measuring the pressure difference between the suction side and the pressure side.

27. Wind turbine according to claim 19, in which the sensor comprises a wind speed meter.

28. Wind turbine according to claim 26, in which the sensor is provided at a distance from the root end which is less than 20% of the span.

29. Wind turbine according to claim 19, in which the air-displacement means are designed for alternately forcing air out of and into the openings (12) at a frequency of 0.1-500 Hz, such as 0.1-100 Hz.

30. Wind turbine according to claim 19, in which each rotor blade (3, 4, 5) has an azimuth angle which is defined by the angle from the vertical which extends upwards up to said rotor blade (3, 4, 5) viewed in the direction of rotation, and in which an angle sensor is provided for detecting the azimuth angle, and the control unit (17) is designed for switching on the air-displacement means at an azimuth angle between 135-245° and switching off the air-displacement means at an azimuth angle outside this range.

31. Wind turbine according to claim 19, in which the air-displacement means are provided with at least one air chamber (15), which is provided inside the rotor blade (3, 4, 5) and is connected to at least one of the openings (12), and in which the air chamber (15) is provided with means for changing the volume of the air chamber (15) for forcing air out of and into the associated opening (12).

32. Wind turbine according to claim 31, in which the means for changing the volume of the air chamber (15) comprise a flexible membrane (16).

33. Wind turbine according to claim 19, in which several rotor blades (3, 4, 5) are each provided with openings (12), air-displacement means for alternately forcing air out of and into said openings (12), a sensor for detecting wind speed fluctuations, and a control unit (17) for controlling the air-displacement means depending on the wind speed fluctuations detected by the sensor, in which the rotor blades (3, 4, 5) each have an aerodynamic profile with a suction side and a pressure side, in which at least one opening (12) is provided on the suction side of each rotor blade (3, 4, 5), and in which the control unit (17) is designed for operating the air-displacement means of the respective opening (12) on the suction side if the sensor has detected a positive speed fluctuation, in which at least one opening (12) is provided on the pressure side of each rotor blade (3, 4, 5), and in which the control unit (17) is designed for operating the air-displacement means of the respective opening (12) on the pressure side if the sensor has detected a negative speed fluctuation.

34. Rotor having a number of rotor blades (3, 4, 5), in which at least one rotor blade (3, 4, 5) is provided with openings (12), air-displacement means for alternately forcing air out of and into said openings (12), a sensor for detecting wind speed fluctuations, and a control unit (17) for controlling the air-displacement means depending on the wind speed fluctuations detected by the sensor, in which the rotor blade (3, 4, 5) has an aerodynamic profile with a suction side and a pressure side, in which at least one opening (12) is provided on the suction side, and in which the control unit (17) is designed for operating the air-displacement means of the opening on the suction side if the sensor has detected a positive speed fluctuation, in which at least one opening (12) is provided on the pressure side, and in which the control unit (17) is designed for operating the air-displacement means of the opening on the pressure side if the sensor has detected a negative speed fluctuation.

35. Rotor blade, in which the rotor blade (3, 4, 5) is provided with openings (12), air-displacement means for alternately forcing air out of and into said openings (12), a sensor for detecting wind speed fluctuations, and a control unit (17) for controlling the air-displacement means depending on the wind speed fluctuations detected by the sensor, in which the rotor blade (3, 4, 5) has an aerodynamic profile with a suction side and a pressure side, in which at least one opening (12) is provided on the suction side, and in which the control unit (17) is designed for operating the air-displacement means of the opening on the suction side if the sensor has detected a positive speed fluctuation, in which at least one opening (12) is provided on the pressure side, and in which the control unit (17) is designed for operating the air-displacement means of the opening on the pressure side if the sensor has detected a negative speed fluctuation.

36. Method for operating a wind turbine which is provided with a rotor (2) having a number of rotor blades (3, 4, 5), at least one rotor blade (3, 4, 5) of which is provided with openings (12), air-displacement means for alternately forcing air out of and into said openings (12), a sensor (27) for detecting wind speed fluctuations, and a control unit (17) for controlling the air-displacement means depending on the wind speed fluctuations detected by the sensor, in which the rotor blade (3, 4, 5) has an aerodynamic profile with a suction side and a pressure side, and in which at least one opening (12) is provided on the suction side, and in which at least one opening (12) is provided on the pressure side, which method comprises:
the sensor (27) detecting a wind speed fluctuation,
transmitting a signal from the sensor (27) to the control unit (17), which signal corresponds to the wind speed fluctuation detected by the sensor (27),
the control unit (17) controlling the air-displacement means depending on the signal of the sensor (27),
the control unit (17) operating the air-displacement means of the opening on the suction side if the sensor has detected a positive speed fluctuation,
the control unit (17) operating the air-displacement means of the opening on the pressure.

37. Wind turbine according to claim 27, in which the sensor is provided at a distance from the root end which is less than 20% of the span.
